(19) United States
(12) Patent Application Publication
(10) Pub. No.: US 2006/0099940 A1
(43) Pub. Date: May 11, 2006

(54) Method for changing the status of a mobile apparatus

(76) Inventors: Gerald W. Pfleging, Batavia, IL (US); Rachel M. Pfleging, Batavia, IL (US); George Paul Wilkin, Bolingbrook, IL (US)

Correspondence Address: Lucent Technologies Inc.;Docket Administrator, Room 3J-219, 101 Crawfords Corner Road, Holmdel, NJ, 07733-3030, US

(21) Appl. No.: 10/985,456

(22) Filed: Nov. 10, 2004

(51) Int. Cl. H04M 3/42; H04Q 7/20

(52) U.S. Cl. 455/419; 455/456.1

(57) ABSTRACT

The present invention provides a method for changing the status of a mobile apparatus based upon the velocity of the mobile apparatus. The communication system determines the velocity of a mobile apparatus by calculating the difference between a first position of a mobile apparatus at a first time and a second position of the mobile apparatus at a second time. If the velocity of the mobile apparatus exceeds a predetermined threshold, the communication system changes the status of the mobile apparatus to a sleep state and ends a call that the mobile apparatus is involved in.

### FIELD OF THE INVENTION

The present invention relates generally to mobile computing devices, and more particularly to a method for changing the status of a mobile computing apparatus.

### BACKGROUND OF THE INVENTION

Mobile apparatuses, such as wireless phones, allow users to place and receive calls from a variety of locations. Wireless phones have been programmed such that they can be used while slowly or quickly moving, such as when the user is walking or traveling in a car. This capability can be very useful by allowing the driver or passenger in a car to call others while driving, thereby utilizing otherwise nonproductive driving time productively.

One problem with the mobility of mobile apparatuses is that a driver can become distracted if using a wireless phone while driving. Mobile phones can cause a driver to divert attention from driving while dialing a phone number, answering a call, retrieving voice mail messages, or performing any other tasks that require the driver's attention.

One proposed solution to the problem of distracting a driver has been “hands-free” mobile phones. These phones are like speaker phones and allow a driver to communicate without holding a mobile apparatus in the driver's hand.

Unfortunately, even “hands-free” phones require a driver's attention, and can lead to missing street signs, driving past exits, and even accidents. Therefore, a need exists for a method for increasing the safety of drivers and others on the road in relation to wireless phones.

### BRIEF SUMMARY OF THE INVENTION

The present invention provides a method for changing the status of a mobile apparatus based upon the velocity of the mobile apparatus. The communication system determines if there is a velocity restriction for a mobile apparatus. The present invention provides safety on roads, as well as allows companies to implement a prohibition upon the use of a cellular phone while driving a company vehicle. In an exemplary embodiment, the communication system determines that there is a velocity restriction for the mobile apparatus upon power up of the mobile apparatus. If there is no velocity restriction for the mobile apparatus, the mobile apparatus is allowed to perform the normal functions of the mobile apparatus.

The speed of the mobile apparatus is determined using several methods. In a first exemplary embodiment, GPS is used to determine the velocity of the mobile apparatus. In a second exemplary embodiment, a triangulation technique is used to determine the speed of the mobile apparatus.

The communication system changes the status of the mobile apparatus if there is a velocity restriction for the mobile apparatus and the velocity exceeds a predetermined threshold. In an exemplary embodiment, the communication system changes the status of the mobile apparatus by restricting the mobile apparatus such that it reduces the feature set of the mobile apparatus to alert only, with no transmission or reception. For example, the mobile apparatus may be powered down or transitioned to a sleep or hibernate mode. Emergency services are still preferably active for the mobile apparatus.

The communication system may present an alert on the mobile apparatus prior to changing the status of the mobile apparatus. In an exemplary embodiment, the disabling of the mobile apparatus based upon the velocity of the mobile apparatus can be overridden.

### BRIEF DESCRIPTION OF THE SEVERAL VIEWS OF THE DRAWINGS

FIG. 1 depicts a communication system in accordance with an exemplary embodiment of the present invention.

FIG. 2 depicts a flowchart of a method for changing the status of a mobile apparatus in accordance with an exemplary embodiment of the present invention.

FIG. 3 depicts a flowchart of a method for processing an incoming call request to a mobile apparatus in accordance with an exemplary embodiment of the present invention.

FIG. 4 depicts a flowchart of a method for processing a missed call request by a mobile apparatus accordance with an exemplary embodiment of the present invention.

### DETAILED DESCRIPTION OF THE INVENTION

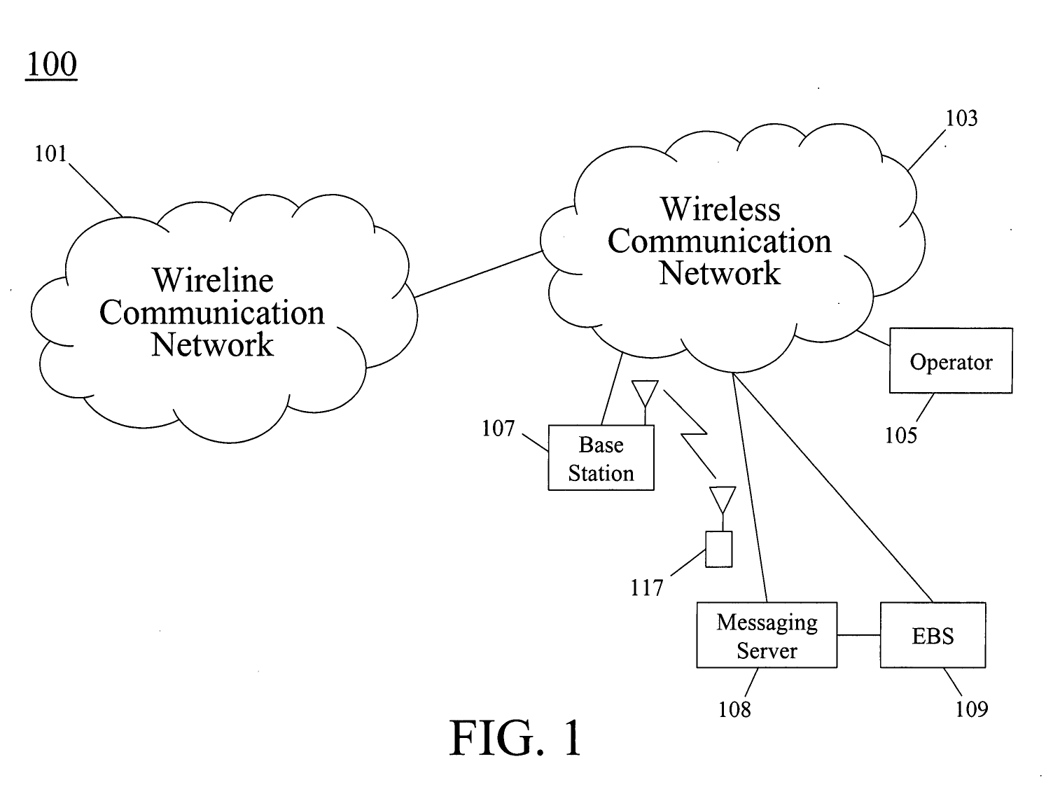

FIG. 1 depicts a communication system 100 in accordance with an exemplary embodiment of the present invention. Communication system 100 includes wireline communication network 101 and wireless communication network 103. Communication system 100 may include a plurality of wireless networks, but only wireless communication network 103 is depicted in FIG. 1 for clarity.

Wireline communication network 101 is a wireline network that allows wireline devices to access a telephone network, such as the Public Switched Telephone Network (PSTN).

Wireless communication network 103 includes at least one Mobile Switching Center (MSC), an Operator 105, a base station 107, a messaging server 108, and an enhanced business server 109. Each MSC is connected to a plurality of base stations, although only a single base station 107 is depicted in FIG. 1 for clarity.

Wireless communication network 103 can utilize any wireless protocol, including but not limited to analog, such as AMPS, TACS and NMT, or digital, such as GSM, TDMA, CDMA, GPRS, EDGE, IS-95, IS-95B, HDR, WCDMA, and CDMA2000.

Base station 107 communicates with wireless communication network 103 via an MSC and communicates over the air with mobile apparatus 117. Although only one base station and one wireless unit are depicted in FIG. 1 for clarity, it should be understood that wireless communication network 103 typically includes a plurality of MSCs, each of which communicates with a plurality of base stations, and each base station services a plurality of wireless units.

The MSC processes call and service requests initiated by wireless unit 117 and allocates the required transmission and signaling resources.

Operator 105 is preferably a human or automated system that allows a user with a mobile apparatus currently in sleep mode to connect to wireless communication network 103. The operator has the authority to override the sleep state restriction of the mobile apparatus, thereby permitting a call to be completed to a mobile apparatus in the sleep state. Operator 105 preferably notes the location, speed, and other factors associated with the mobile apparatus at the time that the restriction is overridden. This information is preferably stored for later analysis.

Base Station 107 is a wireless station that preferably includes connections to the controlling servers via IP or traditional switching mechanisms.

Messaging server 108 is a messaging platform that is capable of storing incoming messages from callers, performing text-to-speech conversions, allowing for the leaving of email or SMS communications or sending pages to the end users' sleeping mobile apparatus. In an exemplary embodiment, messaging server 108 is an ANYPATH server provided by LUCENT TECHNOLOGIES INC. of Murray Hills, N.J.

EBS (Enhanced Business Services) 109 is a business services server that allows for dialing rules to be applied to enterprise calling systems. EBS 109 allows for automating provisioning and announcement choices and provides functionality for find-me follow-me, interaction to messaging systems and company directories, as well as automating provisioning of enterprise telephony systems. In a preferred embodiment, business services server 109 is a SUREPAY server provided by LUCENT TECHNOLOGIES INC. of Murray Hills, N.J. In an exemplary embodiment, EBS 109 is used in conjunction with messaging server 108 to control when the phone is blocked using preprogrammed dialing rules.

In an exemplary embodiment, mobile apparatus 117 is a wireless phone. In a further exemplary embodiment, mobile apparatus 117 can be a Personal Digital Assistant (PDA), a wireless email terminal, or any other communications device that is capable of movement.

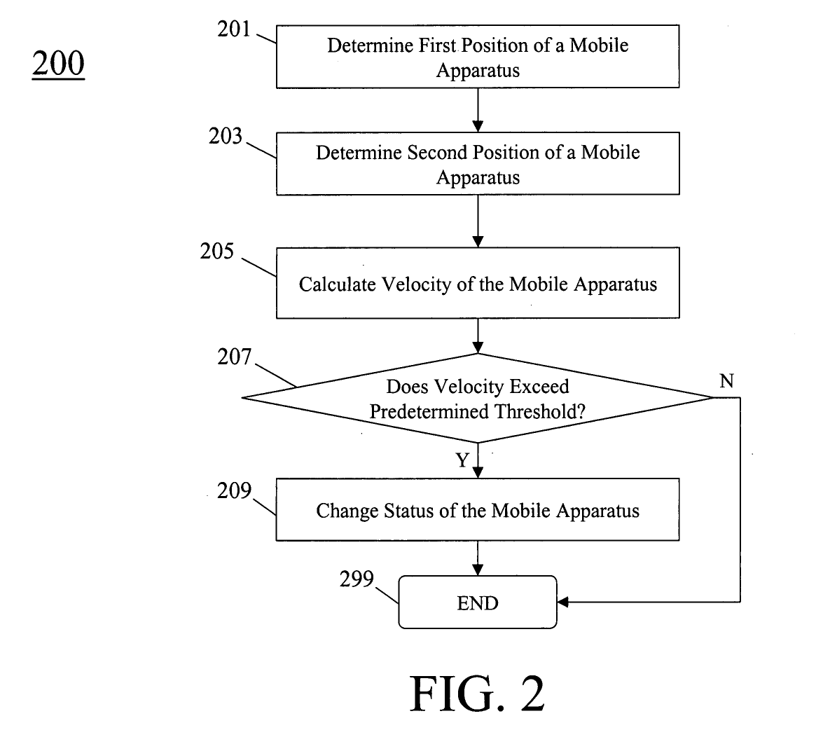

FIG. 2 depicts a flowchart 200 of a method for changing the status of a mobile apparatus in accordance with an exemplary embodiment of the present invention.

The communication system determines (201) a first position of a mobile apparatus. This determination is made at a first time. In an exemplary embodiment, the communication system determines the first position of the mobile apparatus utilizing a Global Positioning System (GPS). In a further exemplary embodiment, the communication system determines the first position of the mobile apparatus utilizing a triangulation technique, such as the method being used for cellular E911 services. The first position of the mobile apparatus can be determined by the mobile apparatus or an interconnected system.

The communication system determines (203) a second position of the mobile apparatus at a second time. The communication system preferably uses the same method for determining the second position as it did to determine the first position.

The communication system calculates (205) the velocity of the mobile apparatus. The calculation utilizes the difference between the first position and the second position, as well as the difference between the first time and the second time.

The communication system determines (207) if the velocity exceeds a predetermined threshold. If the velocity does not exceed the predetermined threshold, the process ends (299) and the mobile apparatus is allowed to perform normal functions.

The predetermined threshold is preferably set to a velocity that is greater than that when walking, so that a subscriber using a mobile apparatus while walking can still communicate, but a subscriber in a car moving above a nominal speed is not able to operate. In an exemplary embodiment, a company that employs drivers determines the predetermined threshold velocity. The present invention provides the company employing the driver to set the threshold to a low driving value, such as five miles per hour, which would prevent a driver from using the phone while driving, unless the drier pulled over and stopped the vehicle.

If the velocity of the mobile apparatus exceeds the predetermined threshold as determined in step 207, the communication system changes (209) the status of the mobile apparatus. In an exemplary embodiment, the status of the mobile apparatus is changed to hibernate, or a sleep state. In this state, the mobile apparatus is powered on but is not able to make or receive calls. In a further exemplary embodiment, the mobile apparatus powers down and becomes inoperable.

In an exemplary embodiment, an alert is presented on the mobile apparatus prior to changing the status of the mobile apparatus. The alert can be a distinctive audible tone to alert the user that the status is about to be changed. In further exemplary embodiments, other means of alerting the user can be used, including but not limited to vibration and flashing lights on the mobile apparatus.

In an exemplary embodiment, the mobile apparatus can override the status change by accepting a password, utilizing an encryption device, or any other way of confirming that the user has the permission to override the status change of the mobile apparatus.

In an exemplary embodiment, exception can be made to override the sleep state so that a user may use the mobile apparatus in certain circumstances. For example, one exception can be for the making or receiving of emergency calls. A further example of an exception to the sleep state can be an override of the status change, for example if the user of the mobile apparatus is a passenger in the car.

In an exemplary embodiment of the present invention, a user of a mobile apparatus overrides the velocity restriction through an automated or human-based system, such as operator 105. In one embodiment, the communication system notes the time and speed of the person traveling for later investigation or allow a party who is not driving to state they are not at the wheel to use the phone.

The communication system preferably ends the call if the velocity exceeds a predetermined threshold. In an further exemplary embodiment, the communication system places the call on hold if the velocity exceeds a predetermined threshold. The call may be resuming after the velocity of the mobile apparatus drops below the predetermined threshold.

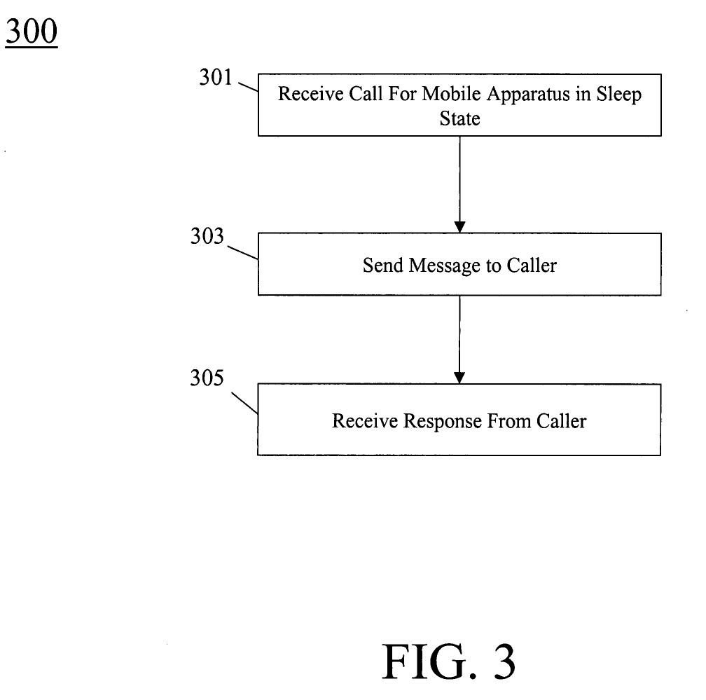

FIG. 3 depicts a flowchart 300 of a method for processing an incoming call request to a mobile apparatus that is moving in accordance with an exemplary embodiment of the present invention.

The communication system receives (301) a call for a mobile apparatus that is in a sleep state. The mobile apparatus is in a sleep state because the communication system has determined that the mobile apparatus includes a velocity restriction and the mobile apparatus is moving faster than a predetermined threshold.

The communication system sends (303) a message to the caller, preferably via messaging server 108. The message preferably indicates to the caller that the called mobile apparatus is currently not able to receive the call because the mobile apparatus is in a sleep state due to it moving faster than the predetermined threshold.

The caller is then preferably presented with a set of options. The options include leaving a message for the mobile apparatus, sending a text message to the mobile apparatus, preferably using a voice to text converter, sending an email to the mobile apparatus, or paging the mobile apparatus.

The communication system receives (305) a response to the message. The communication system processes the response, which varies depending upon the option selected.

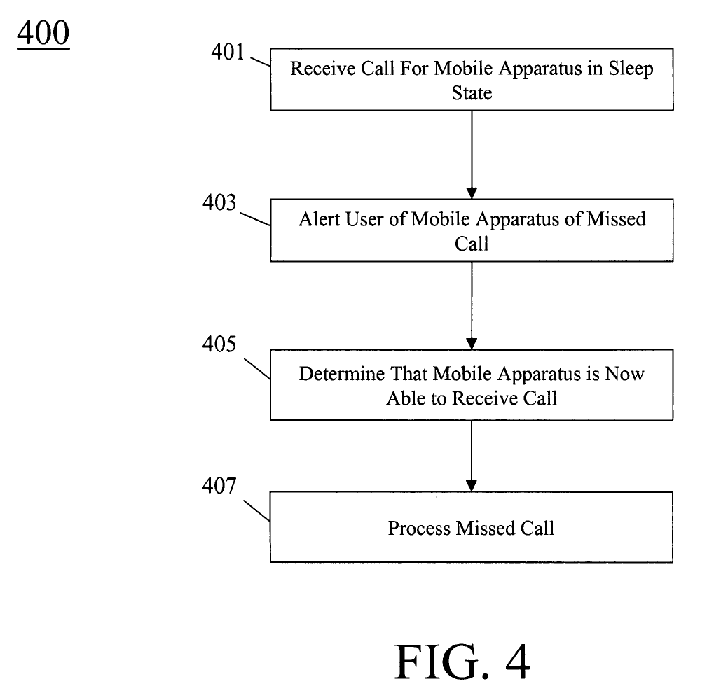

FIG. 4 depicts a flowchart 400 of a method for processing a missed call request by a mobile apparatus that is subject to a velocity restriction in accordance with an exemplary embodiment of the present invention.

The communication system receives (401) a call for a mobile apparatus that is currently in a sleep state. The sleep state is induced for the mobile apparatus when the communication system determines that the mobile apparatus is moving faster than a predetermined threshold.

The communication system alerts (403) a user of the mobile apparatus of a missed call. In an exemplary embodiment, the mobile apparatus plays a distinctive audible tone to alert the user that a call has been received for the mobile apparatus while it is in a sleep state. In further exemplary embodiments, other means of alerting the user can be used, including but not limited to vibration, flashing lights on the mobile apparatus, paging the user, or emailing the user.

The communication system determines (405) that the mobile apparatus is now able to receive a call. In an exemplary embodiment, the communication system makes this determination by determining that the velocity of the mobile apparatus has dropped below the predetermined threshold for a predetermined period of time. The velocity of the mobile apparatus can be determined by the techniques described above, including but not limited to utilizing GPS or triangulation techniques. In an exemplary embodiment, the communication system can determine that the mobile apparatus is now able to receive a call by overriding the restriction.

The user of the mobile apparatus processes (407) the missed call. The user of the mobile apparatus can listen to a message left by the caller of call back the caller. In the scenario in which a call has been placed on hold due to the mobile apparatus exceeding the predetermined velocity threshold during the call, the communication system may place the call on hold and resume the call after the mobile apparatus stops moving or its velocity drop below the predetermined threshold. The user of the mobile apparatus may use a callback feature to place a call to the caller.

While this invention has been described in terms of certain examples thereof, it is not intended that it be limited to the above description, but rather only to the extent set forth in the claims that follow.

We claim:

1. A method for changing the status of a mobile apparatus, the method comprising:
determining a first position of a mobile apparatus at a first time;
determining a second position of the mobile apparatus at a second time;
calculating the velocity of the mobile apparatus based at least in part upon the difference between the second position and the first position and the difference between the second time and the first time; and
changing the status of the mobile apparatus if the velocity exceeds a predetermined threshold.

2. A method for changing the status of a mobile apparatus in accordance with claim 1, wherein the mobile apparatus is involved in a call, the method further comprising the step of ending the call if the velocity exceeds a predetermined threshold.

3. A method for changing the status of a mobile apparatus in accordance with claim 1, wherein the mobile apparatus is involved in a call, the method further comprising the step of placing the call on hold if the velocity exceeds a predetermined threshold.

4. A method for changing the status of a mobile apparatus in accordance with claim 3, the method further comprising the step of resuming the call after the velocity of the mobile apparatus drops below the predetermined threshold.

5. A method for changing the status of a mobile apparatus in accordance with claim 1, wherein the step of changing the status of the mobile apparatus comprises the step of disabling the mobile apparatus.

6. A method for changing the status of a mobile apparatus in accordance with claim 1, wherein the step of determining the first position of the mobile apparatus comprises utilizing a Global Positioning System (GPS).

7. A method for changing the status of a mobile apparatus in accordance with claim 1, wherein the step of determining the first position of the mobile apparatus comprises utilizing a triangulation technique.

8. A method for changing the status of a mobile apparatus in accordance with claim 1, wherein the step of changing the status of the mobile apparatus comprises setting the mobile apparatus to hibernate mode.

9. A method for changing the status of a mobile apparatus in accordance with claim 1, the method further comprising the step of, prior to changing the status of the mobile apparatus, presenting an alert on the mobile apparatus.

10. A method for disabling a mobile apparatus comprising:
determining the speed of a mobile apparatus; and
disabling the mobile apparatus if the speed exceeds a predetermined threshold.

11. A method for disabling a mobile apparatus in accordance with claim 10, wherein the mobile apparatus is involved in a call, the method further comprising the step of ending the call if the speed exceeds a predetermined threshold.

12. A method for disabling a mobile apparatus in accordance with claim 11, the method further comprising the step of resuming the call after the velocity of the mobile apparatus drops below the predetermined threshold.

13. A method for disabling a mobile apparatus in accordance with claim 10, the method further comprising the step of overriding the disabling of the mobile apparatus.

14. A method for disabling a mobile apparatus based on the velocity of the mobile apparatus, the method comprising:
determining if there is a velocity restriction for a mobile apparatus;
determining the velocity of the mobile apparatus; and
disabling the mobile apparatus if there is a velocity restriction for the mobile apparatus and the velocity exceeds a predetermined threshold.

15. A method for disabling a mobile apparatus based on the velocity of the mobile apparatus in accordance with claim 14, wherein the step of determining if there is a velocity restriction for the mobile apparatus comprises determining if there is a velocity restriction for the mobile apparatus upon power up of the mobile apparatus.

16. A method for disabling a mobile apparatus based on the velocity of the mobile apparatus in accordance with claim 14, the method further comprising the step of allowing the mobile apparatus to perform the functions of the mobile apparatus if the mobile apparatus does not have a velocity restriction.

17. A method for disabling a mobile apparatus based on the velocity of the mobile apparatus in accordance with claim 14, the method further comprising the step of overriding the disabling of the mobile apparatus.

18. A method for disabling a mobile apparatus based on the velocity of the mobile apparatus in accordance with claim 14, wherein the step of disabling the mobile apparatus comprises powering down the mobile apparatus.

19. A method for disabling a mobile apparatus based on the velocity of the mobile apparatus in accordance with claim 14, wherein the step of disabling the mobile apparatus comprises setting the mobile apparatus to hibernate mode.

20. A method for disabling a mobile apparatus based on the velocity of the mobile apparatus in accordance with claim 14, the method further comprising the step of, prior to disabling the mobile apparatus, presenting an alert on the mobile apparatus.
